(19) United States
(12) Patent Application Publication
(10) Pub. No.: US 2003/0138527 A1
(43) Pub. Date: Jul. 24, 2003

(54) Animated figure on non-animated objected pop combination

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Melvin L. Crane, 318 South Cleveland Street, Arlington, VA, 22204-2038, US

(21) Appl. No.: 10/054,572

(22) Filed: Jan. 24, 2002

(51) Int. Cl. A23G 1/00

(52) U.S. Cl. 426/104

(57) ABSTRACT

An animated or non-animated body candy pop device comprising a main housing or body including a pliable material with a wire or stiffener in the body so that the body can be shaped into different shapes. The main housing can be solid or hollow and made with an expandable sleeve in the body for receiving an end of a candy stick on which a pop is secured. The pop can be formed directly on one or more appendages of the body instead of using the stick holder. The candy can be replaced with any type of lollipop. The device can be made in different body styles such as animals, fish, and insects, etc., to provide fun and entertainment for children of all ages.

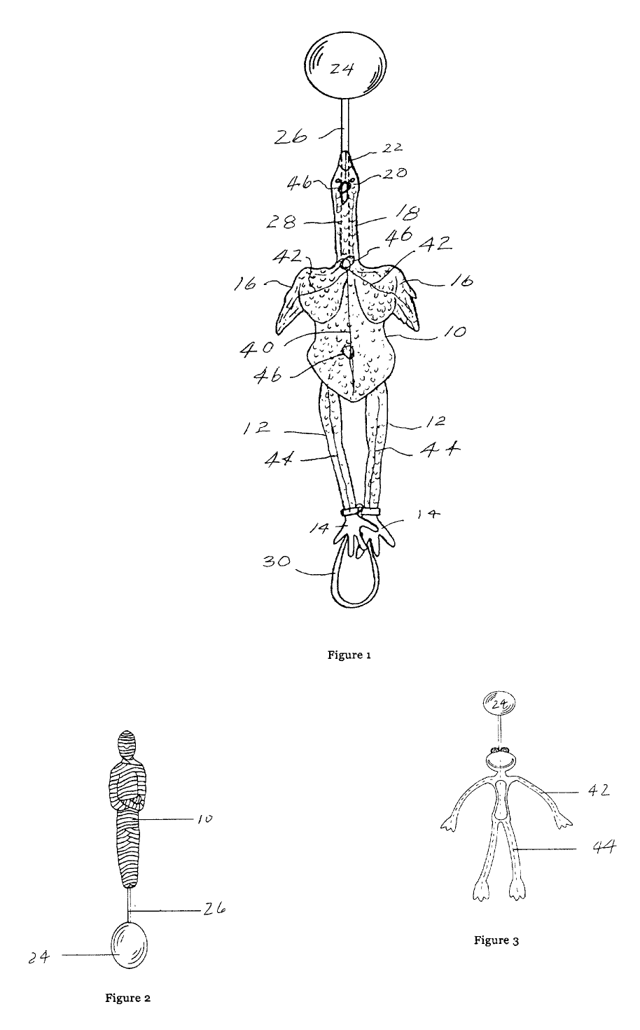

### CROSS-REFERENCE TO RELATED APPLICATION

This invention is an improvement over U.S. Pat. No. 6,090,530 dated Jul. 18, 2000.

### BACKGROUND OF THE INVENTION

This invention is directed to a candy pop and more particularly to an animated or non-animated flexible material such as rubber or soft plastic in combination with a candy pop.

Heretofore, candy pops have been held by many different arrangements for consumption by a person. Some patents are as follows: U.S. Pat. Nos. 5,222,627; 5,375,848; 5,370,884; 5,531,318, and 5,676,988. A toy including an animated chicken head has been set forth in U.S. Pat. No. 3,570,173.

### SUMMARY OF THE INVENTION

The present invention is directed to a flexible animated or non-animated pop holder which includes a look-alike of a non-live chicken or any other living or non-living object and which supports a candy pop on its body. The device can be held by hand while in use or hung by some means on a person's body, such as by a belt, when not in use.

It is therefore an object of the invention to form an animated or non-animated candy pop holder which is comical and would be amusing to the user, as well as others who observe the device.

Another object of the invention is to provide an animated or non-animated candy pop holder which is made of any suitable material which is pliable such as rubber or plastic which may have a wire stiffener.

Yet another object is to provide an animated or non-animated candy pop holder which can be used to hold different sized candy pop sticks for different sized candy pops in a candy holder somewhere on its body.

The foregoing, along with additional features, advantages, and benefits of the invention, will be obvious from the ensuing description and claims which are accompanied by the drawing.

### BRIEF DESCRIPTION OF THE DRAWING

The drawing is a top view of an animated chicken candy pop shown without any feathers on the body.

### DESCRIPTION OF THE PREFERRED EMBODIMENT

Now referring to the drawing, there is shown an animated chicken candy pop including a body 10, legs 12, feet 14, wings 16, a neck 18, a head 20, a mouth 22, and a candy pop 24 secured to the body by a stick 26. The body can be solid or hollow and made of any suitable material such as a pliable material which would present a “limp” feeling. It is known that animated chickens have been made of rubber; however, it could be made with any pliable material. As shown by dotted lines, an expandable sleeve 28 is provided within the neck portion and the mouth provides an opening in which the candy pop stick 26 is inserted and which is held by the outer end of the expandable sleeve. Since the animated chicken is made of a pliable material, the neck portion of the chicken will expand with the expandable sleeve. The sleeve is made of expandable material in order to receive therein different sized candy pop sticks so that different sized candy pop sticks can be held in place for use by the user. As shown, the feet of the chicken are bound together by a hanger loop 30 which can be used to support the animated chicken candy pop for display for selling the device or for securing the device onto a person for use. The loop could be placed around a person's wrist for consumption of the candy pop or hung onto a person's belt for carrying the device when the candy pop is not being consumed.

The expandable sleeve not only serves to secure the candy pop stick 26 within the mouth of the animated chicken, but also serves to make the neck portion slightly rigid. In addition to the expandable sleeve, a noisemaker could be added to the neck portion that would make a noise when the neck is bent slightly. Such a noisemaker could be a material which would make a noise when the material is bent and which would return to its normal straight position when released from being bent. Thus, an added feature for amusement of the user or others would be provided.

The candy pop can be replaced subsequent to being consumed by withdrawing the candy stick and then replacing the candy stick by a candy pop on a stick. The candy pop could be secured to the mouth and not be replaceable.

The device has been shown and described as an animated chicken; however, the device could be made with any other body style such as a person, an animal, a fish, an insect, etc. Such a device will provide amusement and entertainment for persons of all ages.

The pliable material can be formed with a soft wire or stiffener frame in which the wire or stiffener 40 extends along the body from the tail to the mouth, with wire 42 in the wings and wire 44 along each of the legs. In addition, the animated or non-animated device is made with a different candy stick holder 46 which can be formed in any portion of the body such as shown in the figure between the wing area or near the tail area. Additionally, the feet can be formed to hold a candy stick holder. Also, an amusing chicken would be one with a candy pop formed on each of the wings, on each foot, or any other place, as well as extending from the top of the head.

The teaching of this invention is one in which a candy pop can extend from any part of a body which can be twisted or bent into different shapes. With a wire such as shown in the chicken, the chicken as well as other animated or non-animated objects can be made of a pliable material and made into other shapes which will remain in the fixed shape because of the wire form.

The foregoing relates to preferred exemplary embodiments of the invention, it being understood that other variants and embodiments thereof are possible within the spirit and scope of the invention, the latter being defined by the appended claims.

We claim:

1. An animated or non-animated body candy pop device in which said animated or non-animated body is made of a pliable material, and
a candy pop adapted to be secured to a body portion of the animated or non-animated body.

2. An animated or non-animated body candy device as set forth in claim 1, wherein
said animated or non-animated body may have a bendable stiffener material in the body which permits forming different shapes.

3. An animated or non-animated body candy pop device as set forth in claim 1, wherein
the candy pop is secured to an appendage of the body portion.

4. An animated or non-animated body candy pop device as set forth in claim 3, wherein
the candy pop is secured directly to the appendage.

5. An animated or non-animated body candy pop device as set forth in claim 3, in which
the candy pop is secured on a stick which is held on said body in a stick holder.

6. An animated or non-animated body candy pop device as set forth in claim 5, in which
the stick holder is of an expandable type.
